(19) United States
(12) Patent Application Publication
(10) Pub. No.: US 2014/0003880 A1
(43) Pub. Date: Jan. 2, 2014

(54) CERAMIC MATRIX COMPOSITE AND METAL ATTACHMENT CONFIGURATIONS

(71) Applicant: GENERAL ELECTRIC COMPANY, Schenectady, NY (US)

(72) Inventor: James Hamilton GROOMS, II, Hamilton, OH (US)

(73) Assignee: GENERAL ELECTRIC COMPANY, Schenectady, NY (US)

(21) Appl. No.: 13/803,246

(22) Filed: Mar. 14, 2013

Related U.S. Application Data
(60) Provisional application No. 61/666,826, filed on Jun. 30, 2012.

(51) Int. Cl. F16B 35/00

(52) U.S. Cl. CPC F16B 35/00
USPC 411/378

(57) ABSTRACT

A ceramic matrix composite (CMC) and metal attachment configuration is provided. The CMC and metal attachment may include a metal plate, a CMC plate, a spacer, a metal bolt and a nut. Metal plate may include metal plate aperture. CMC plate may be adjacent metal plate and may include CMC plate aperture aligned with metal plate aperture. Spacer may be adjacent to CMC, and spacer may include spacer aperture aligned with metal plate and CMC apertures. Metal bolt may have first and second ends, second end may be operable to fit into aligned spacer, CMC plate, and metal apertures, to attach spacer, CMC plate and metal plate. Nut may be adjacent to metal plate and may be operable to receive second end of bolt. Spacer may allow metal plate, having a high coefficient of thermal expansion, to be attached to CMC plate, having a low coefficient of thermal expansion.

### CROSS-REFERENCE TO RELATED APPLICATIONS

This patent application claims the benefit of U.S. Provisional Patent Application Ser. No. 61/666,826 filed on Jun. 30, 2012, and entitled “CERAMIC MATRIX COMPOSITE AND METAL ATTACHMENT CONFIGURATIONS,” the disclosure of which is incorporated by reference as if fully rewritten herein.

### FIELD OF THE INVENTION

The present invention relates generally to turbines. More specifically, to attaching ceramic matrix composites (CMC) in gas turbines to metal components with a bolt.

### BACKGROUND OF THE INVENTION

Generally, ceramic matrix composite turbine components require attachment to adjoining metallic hardware and/or metallic surfaces. Two disadvantages associated with attaching a CMC to metallic hardware are the wear of the metallic hardware by the hard, abrasive ceramic material surface, and the lack of load distribution in the CMC. Additionally, differences between the coefficients of thermal expansion between the metal and ceramic matrix composite make attaching metal and ceramic matrix composites challenging.

Therefore, a ceramic matrix composite (CMC) component and a method of attaching a metal component to a CMC component that do not suffer from the above drawbacks is desirable in the art.

### SUMMARY OF THE INVENTION

According to an exemplary embodiment of the present disclosure, a ceramic matrix composite and a metal attachment configuration is provided. The ceramic matrix composite and a metal attachment configuration includes a metal plate having a metal plate aperture. The ceramic matrix composite and a metal attachment configuration includes a ceramic matrix composite plate adjacent the metal plate and having a ceramic matrix composite plate aperture aligned with the metal plate aperture. The ceramic matrix composite and a metal attachment configuration includes a spacer adjacent to the ceramic matrix composite, the spacer having a spacer aperture aligned with the metal plate aperture and the ceramic matrix composite aperture. The ceramic matrix composite and a metal attachment configuration includes a metal bolt having a first end and a second end, the second end operable to fit into the aligned spacer aperture, ceramic matrix composite plate aperture, and metal aperture to attach the spacer, the ceramic matrix composite plate and the metal plate. The ceramic matrix composite and a metal attachment configuration includes a nut adjacent to the metal plate and operable to receive the second end of the bolt. The spacer allows the metal plate having a high coefficient of thermal expansion to be attached to the ceramic matrix composite plate having a low coefficient of thermal expansion.

According to another exemplary embodiment of the present disclosure, a ceramic matrix composite and metal attachment configuration is provided. The ceramic matrix composite and metal attachment configuration includes a metal plate having a metal plate aperture. The ceramic matrix composite and metal attachment configuration includes a ceramic matrix composite plate adjacent the metal plate and including a ceramic matrix composite plate aperture aligned with the metal plate aperture. The ceramic matrix composite and metal attachment configuration includes a metal bolt having a first end, a second end, and a channel running therethrough. The second end of bolt is operable to fit into the aligned ceramic matrix composite plate aperture, and metal aperture to attach the ceramic matrix composite plate and the metal plate. The ceramic matrix composite and metal attachment configuration includes a nut adjacent to the metal plate and operable to receive the second end of the bolt. The channel of the metal bolt minimizes growth of the bolt relative to the ceramic matrix composite plates due to mismatch of coefficient of thermal expansion between the metal bolt and the metal plate and the ceramic matrix composite plate.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic section view of a ceramic matrix composite and metal attachment configuration of the present disclosure.

FIG. 2 is a schematic section view of a ceramic matrix composite and metal attachment configuration of the present disclosure.

FIG. 3 is a schematic section view of a ceramic matrix composite and metal attachment configuration of the present disclosure.

FIG. 4 is a schematic section view of a ceramic matrix composite and metal attachment configuration of the present disclosure.

FIG. 5 is a front view of a zero CMC thickness joint of the present disclosure.

FIG. 6 is a side view of a zero CMC thickness joint of the present disclosure.

FIG. 7 is a schematic perspective view of a zero CMC thickness joint of the present disclosure.

Wherever possible, the same reference numbers will be used throughout the drawings to represent the same parts.

### DETAILED DESCRIPTION OF THE INVENTION

Provided are ceramic matrix composite and metal attachment configurations to attach ceramic matrix composites to metal components having different coefficients of thermal expansions.

One advantage of an embodiment of the present disclosure includes providing an attachment configuration for attaching CMC components that have a low thermal expansion coefficient (α_{CMC}) to metal component that have a high thermal expansion coefficient (αₘₑₜₐₗ) relative to CMC components.

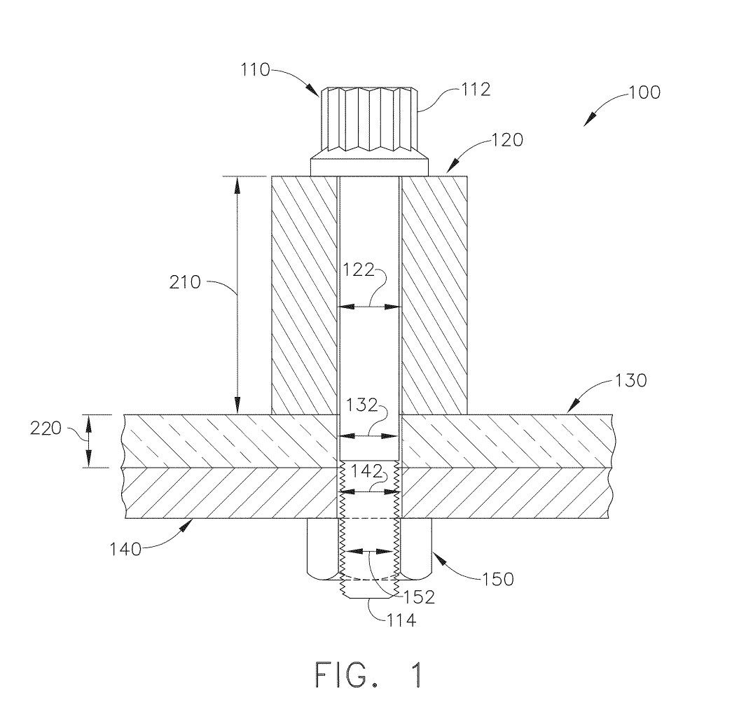

According to one embodiment a ceramic matrix composite and metal attachment configuration including a metal plate and a ceramic matrix composite plate is provided. For example, FIG. 1 is a schematic section view of a ceramic matrix composite and metal attachment configuration 100. Ceramic matrix composite and metal attachment configuration 100 may include a metal plate 140 having a metal plate aperture 142. Metal plate may have a high coefficient of thermal expansion (αₘₑₜₐₗ), relative to CMC components. Ceramic matrix composite and metal attachment configuration 100 may include a ceramic matrix composite plate 130 adjacent metal plate 140. Ceramic matrix composite plate 130 may have a ceramic matrix composite plate aperture 132 aligned with metal plate aperture 142. Ceramic matrix composite may have a low coefficient of thermal expansion (α_{CMC}), which is generally less than the coefficient of thermal expansion of metal components. Ceramic matrix composite and metal attachment configuration 100 may include a spacer 120 adjacent to ceramic matrix composite 130. Spacer 120 may include a spacer aperture 122 aligned with metal plate aperture 142 and ceramic matrix composite aperture 132. Ceramic matrix composite and metal attachment configuration 100 may include a metal bolt 110. Metal bolt 110 may have a first end 112 and a second end 114, second end 114 may be operable to fit into aligned spacer aperture 122, ceramic matrix composite plate aperture 132, and metal aperture 142 to attach spacer 120, ceramic matrix composite plate 130 and metal plate 140. Ceramic matrix composite and metal attachment configuration 100 may include a nut 150 adjacent to metal plate 140, nut 150 may be operable to receive second end 114 of metal bolt 110. For example, in one embodiment, spacer 120 may allow metal plate 140 having a high coefficient of thermal expansion to be attached to ceramic matrix composite plate 130 having a low coefficient of thermal expansion.

According to one embodiment, spacer may be a metal and have a coefficient of thermal expansion that is the same or different from the metal bolt or metal plate. For example, in FIG. 1, spacer 120 may be a metal and may have the same coefficient of thermal expansion as metal bolt 110. In an alternative embodiment, spacer 120 may be a metal and have the same coefficient of thermal expansion as metal plate 140. Suitable materials for spacer 120, bolt 110, and metal plate 140 may include, but are not limited to, metal, metal alloys, and combinations thereof, for example metal alloys may include nickel-based superalloys, cobalt-based superalloys, or combinations thereof. Thickness 210 of spacer 120 will be larger than the thickness 220 of ceramic matric composite plate 130.

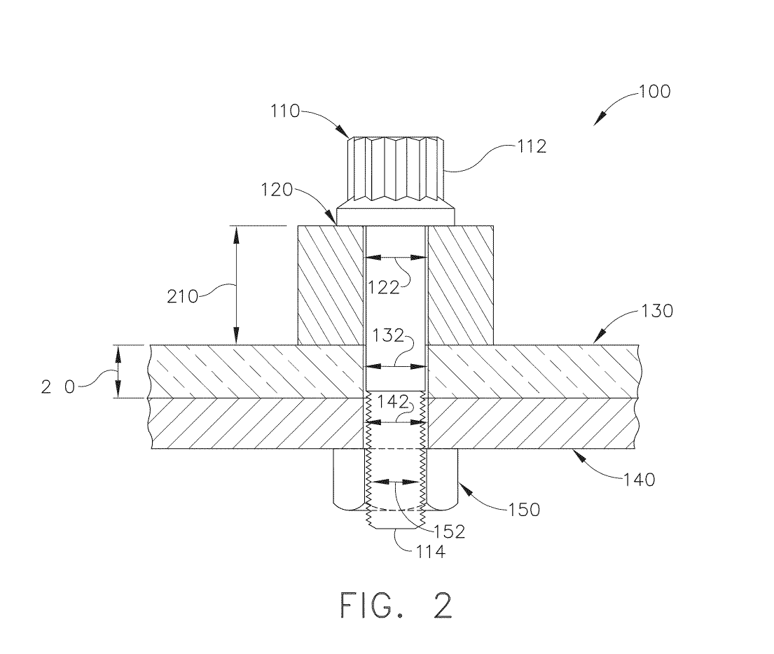

According to one embodiment, ceramic matrix composite and metal attachment configuration may include metal plate, ceramic matrix composite plate, spacer, metal bolt, and nut. For example, as shown in FIG. 2, ceramic matrix composite and metal attachment configuration 100 may include metal plate 140, ceramic matrix composite plate 130, spacer 120, metal bolt 110 and nut 150. In this embodiment, spacer 120 may have a coefficient of thermal expansion greater than that of metal bolt 110. Spacer 120 may have a thickness 210. Ceramic matrix composite plate 130 has a thickness 220. Thickness 210 of spacer 120 may be about 2.5 times greater than thickness 220 of ceramic matrix composite plate 130.

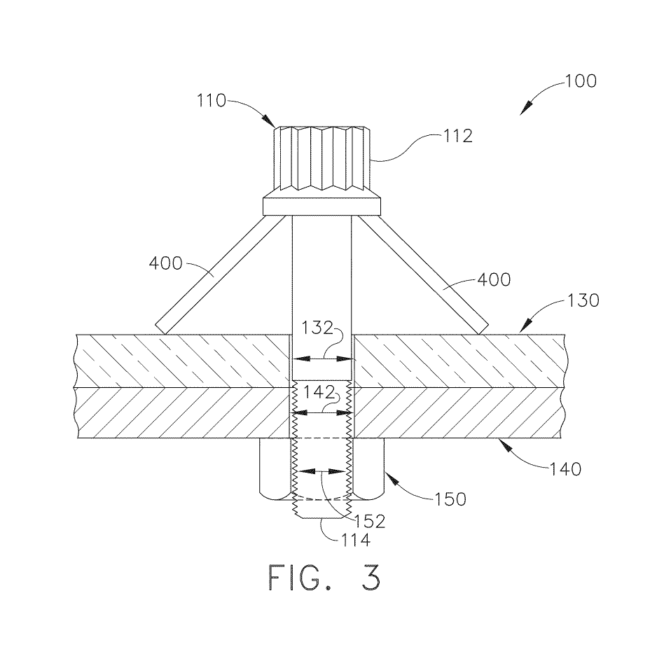

According to one embodiment ceramic matrix composite and metal attachment configuration may include a metal plate, a ceramic matrix composite plate, a metal bolt, a nut, and a spring. For example, in FIG. 3, ceramic matrix composite and metal attachment configuration 100 may include metal plate 140, ceramic matrix composite plate 130, metal bolt 110 and nut 150. In this embodiment, bolt 110 may include a spring 400 attached to first end 112 of metal bolt 110. Spring 400 may be a metal, including but not limited to, metals, metal alloys, for example, metal alloys may include, but are not limited to nickel-based superalloys, cobalt-based superalloys and combinations thereof. The coefficient of thermal expansion of spring (α_{spring}) may be similar to the coefficients of thermal expansion of metal plate (αₘₑₜₐₗ) or bolt (α_{bolt}). In an alternative embodiment, coefficient of thermal expansion of spring (α_{spring}) may be greater than the coefficients of thermal expansion of metal plate (αₘₑₜₐₗ) or bolt (α_{bolt}). As shown in FIG. 3, spring 400 may be a joint spring. In an alternative embodiment, spring 400 may be a coil spring, Bellville spring, wave spring, or leaf spring. In operation, spring 400 cooperates with ceramic matrix composite plate 130.

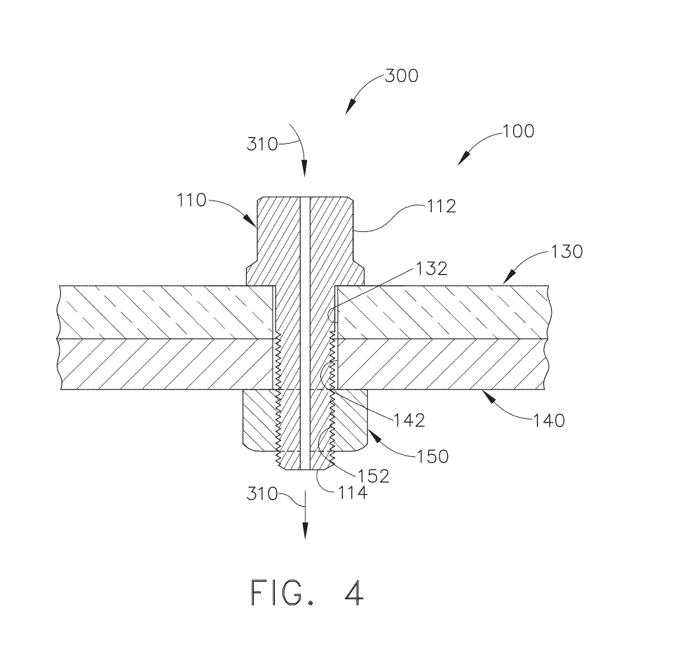

According to one embodiment, a ceramic matrix composite and metal attachment configuration is provided. For example as shown in FIG. 4 ceramic matrix composite and metal attachment configuration 100 may include a metal plate 140 having a metal plate aperture 142. Ceramic matrix composite and metal attachment configuration 100 may include a ceramic matrix composite plate 130 adjacent metal plate 140. Ceramic matrix composite plate 130 may include a ceramic matrix composite plate aperture 132 aligned with metal plate aperture 142. Ceramic matrix composite and metal attachment configuration 100 may include a metal bolt 110 having a first end 112, a second end 114, and a channel 300 running therethrough. Second end 114 of metal bolt 110 may be operable to fit into the aligned ceramic matrix composite plate aperture 132, and metal aperture 142 to attach ceramic matrix composite plate 130 and metal plate 140. Ceramic matrix composite and metal attachment configuration 100 may include a nut 150 adjacent to metal plate 140 and operable to receive second end 114 of metal bolt 110. Channel 300 of metal bolt 110 may minimize growth of bolt 110 due to mismatch of coefficient of thermal expansion between the metal bolt 110 and metal plate 140 and ceramic matrix composite plate 130. For example, as shown in FIG. 4, channel 300 of bolt allows cooling air 310 to flow through bolt 110. Channel 300 of bolt 110 may provide a cooler bolt temperature than a bolt not having a channel. The cooler bolt will grow less relative to the ceramic matrix composite plate 130.

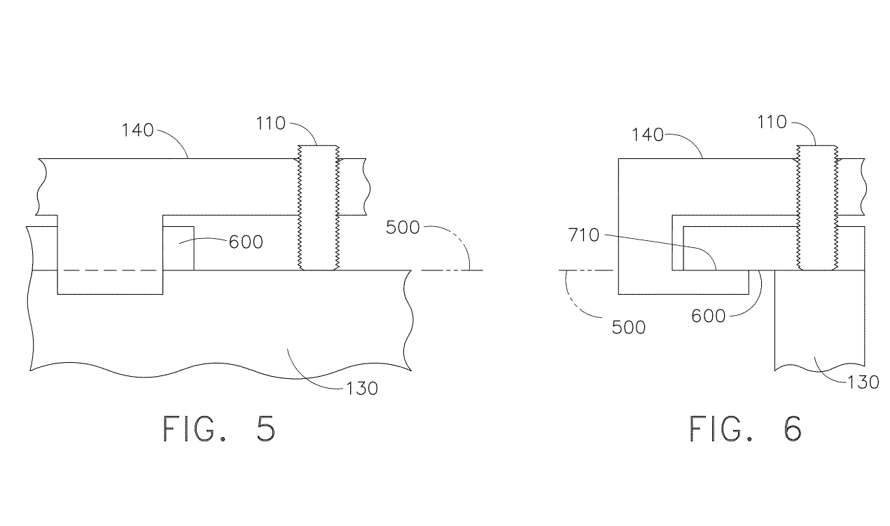

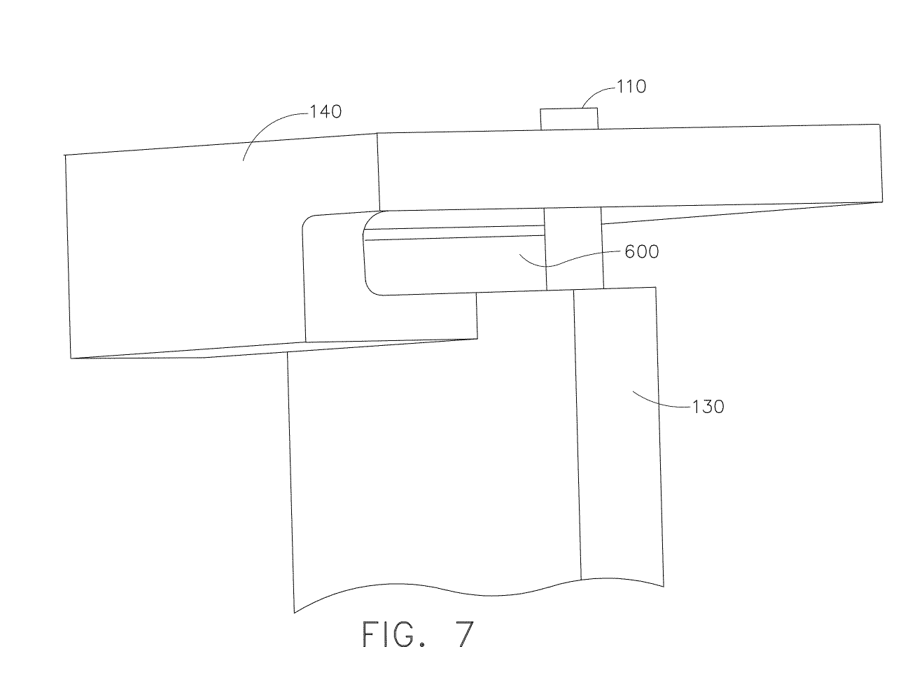

According to one embodiment, a zero CMC thickness joint may be obtained. For example, as shown in FIGS. 5-7, CMC hook 600 and stop 710 may be created such that metal components can be wrapped around CMC plate 130. Zero point thickness may be illustrated by line 500 in FIGS. 5 and 6. Metal 140 may pull and may push on CMC 130 at the same datum location. This method may eliminate CMC from the bolted joint alpha mismatch because all length of metal that may be clamping may be matched with length of metal that may be clamped.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A ceramic matrix composite and a metal attachment configuration comprising:
a metal plate including a metal plate aperture;
a ceramic matrix composite plate adjacent the metal plate and including a ceramic matrix composite plate aperture aligned with the metal plate aperture;
a spacer adjacent to the ceramic matrix composite, the spacer including a spacer aperture aligned with the metal plate aperture and the ceramic matrix composite aperture; and
a metal bolt having a first end and a second end, the second end operable to fit into the aligned spacer aperture, ceramic matrix composite plate aperture, and metal aperture to attach the spacer, the ceramic matrix composite plate and the metal plate.

2. The ceramic matrix composite and metal attachment configuration of claim 1, wherein the spacer allows the metal plate having a high coefficient of thermal expansion to be attached to the ceramic matrix composite plate having a low coefficient of thermal expansion.

3. The ceramic matrix composite and metal attachment configuration of claim 1, further comprising a nut adjacent to the metal plate and operable to receive the second end of the bolt.

4. The ceramic matrix composite and metal attachment configuration of claim 1, wherein the spacer has the same coefficient of thermal expansion as the bolt.

5. The ceramic matrix composite and metal attachment configuration of claim 1, wherein the spacer has the same coefficient of thermal expansion as the metal plate.

6. The ceramic matrix composite and metal attachment configuration of claim 1, wherein the spacer has a coefficient of thermal expansion greater than that of the bolt.

7. The ceramic matrix composite and metal attachment configuration of claim 1, wherein the spacer has a thickness greater than that of the ceramic matric composite plate.

8. The ceramic matrix composite and metal attachment configuration of claim 1, wherein a thickness of the spacer is about 2.5 times greater than a thickness of the ceramic matrix composite plate.

9. The ceramic matrix composite and metal attachment configuration of claim 1, wherein the bolt includes a spring attached to the first end of the bolt.

10. The ceramic matrix composite and metal attachment configuration of claim 9, wherein the spring cooperates with the ceramic matrix composite plate.

11. The ceramic matrix composite and metal attachment configuration of claim 9, wherein the spring has a coefficient of thermal expansion similar to a coefficient of thermal expansion of the metal plate.

12. The ceramic matrix composite and metal attachment configuration of claim 9, wherein the spring has a coefficient of thermal expansion similar to a coefficient of thermal expansion of the bolt.

13. The ceramic matrix composite and metal attachment configuration of claim 9, wherein the spring has a coefficient of thermal expansion greater than a coefficient of thermal expansion of the metal plate.

14. The ceramic matrix composite and metal attachment configuration of claim 9, wherein the spring has a coefficient of thermal expansion greater than a coefficient of thermal expansion of the bolt.

15. A ceramic matrix composite and metal attachment configuration comprising:
a metal plate including a metal plate aperture;
a ceramic matrix composite plate adjacent the metal plate and including a ceramic matrix composite plate aperture aligned with the metal plate aperture; and
a metal bolt having a first end, a second end, and a channel running therethrough, the second end operable to fit into the aligned ceramic matrix composite plate aperture, and metal aperture to attach the ceramic matrix composite plate and the metal plate.

16. The ceramic matrix composite and metal plate attachment configuration of claim 15, further comprising a nut adjacent to the metal plate and operable to receive the second end of the bolt.

17. The ceramic matrix composite and metal plate attachment configuration of claim 15, wherein the channel of the metal bolt minimizes growth of the bolt relative to the ceramic matrix composite plate due to mismatch of coefficient of thermal expansion between the metal bolt and the metal plate and the ceramic matrix composite plate.

18. The ceramic matrix composite and metal plate attachment configuration of claim 15, wherein the channel of the bolt allows cooling air to flow through the bolt.

19. The ceramic matrix composite and metal plate attachment configuration of claim 15, wherein the channel of the bolt provides a cooler bolt temperature than a bolt not having a channel.

20. The ceramic matrix composite and metal plate attachment configuration of claim 15, wherein a zero CMC thickness joint is obtained.
